(19) United States
(12) Patent Application Publication
(10) Pub. No.: US 2010/0079655 A1
(43) Pub. Date: Apr. 1, 2010

(54) METHOD OF CONTROLLING DIGITAL IMAGE SIGNAL PROCESSING APPARATUS AND DIGITAL IMAGE SIGNAL PROCESSING APPARATUS OPERATED BY THE SAME

(75) Inventors: Tae-won Eom, Suwon-si (KR); Hong-ju Kim, Suwon-si (KR); Hyuk-soo Son, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/565,822

(22) Filed: Sep. 24, 2009

(30) Foreign Application Priority Data
Sep. 26, 2008 (KR) 10-2008-094745

(51) Int. Cl. H04N 5/222

(52) U.S. Cl. 348/333.05; 348/362; 348/E05.022

(57) ABSTRACT

An exemplary digital image signal processing apparatus which performs image signal processing on an input image to generate a captured image includes first and second displays. The digital image signal processing apparatus may be operated by a method in which the first display displays a first image corresponding to the input image, an exposure correction is performed on the input image to generate a second image, and the second display displays the second image. An exposure determiner may determine an exposure degree of the first image, a gain may be determined according to the exposure degree, and the exposure correction may be performed by applying the gain to the first image.

### CROSS-REFERENCE TO RELATED PATENT APPLICATION

This application claims the priority benefit of Korean Patent Application No. 10-2008-0094745, filed on Sep. 26, 2008, in the Korean Intellectual Property Office, the disclosure of which is incorporated herein in its entirety by reference.

### BACKGROUND

1. Field of the Invention

The present invention relates to a method of controlling a digital image signal processing apparatus including at least two displays, and the digital image signal processing apparatus operated by the method.

2. Description of the Related Art

A conventional digital camera includes an electronic viewfinder (EVF) and a liquid crystal display (LCD) that respectively display images on which a kind of image signal processing has been performed, in order to facilitate a user's recognizing an image in a live view mode when the user is in a bright place or a dark place.

FIGS. 1A and 1B respectively illustrate under-exposed and over-exposed input images. A conventional digital camera illustrated in FIG. 2A displays images, which are obtained by performing image signal processing on the under-exposed and over-exposed input images, on an EVF A and an LCD B, respectively. The image displayed on the EVF A shown in FIG. 2B is the same as the image displayed on the LCD B shown in FIG. 2A.

However, if a user desires to obtain an under-exposed or over-exposed image as in a manual mode or the like, a captured image is different from the images displayed on the EVF A and the LCD B in the live view mode. In detail, FIG. 3A illustrates an under-exposed image that is captured in a manual mode when the user is in a dark place, and FIG. 3B illustrates an over-exposed image that is captured in a bright place.

Accordingly, the conventional digital camera displays the images, which are different from the captured images illustrated in FIGS. 3A and 3B, on the EVF A and the LCD B in the live view mode. Thus, the user cannot accurately check an exposure of a subject.

FIGS. 1A and 1B, 2A and 2B, and 3A and 3B respectively illustrate under-exposed and over-exposed input images, display images on displays, and output images in the conventional digital camera.

### SUMMARY

An exemplary digital image signal processing apparatus including a first display and a second display may be operated by a method through which a user may check whether images are equal or similar to a captured image.

An exemplary method of controlling a digital image signal processing apparatus which performs image signal processing on an input image to generate a captured image and which has first and second displays includes displaying a first image corresponding to the input image on the first display, performing an exposure correction on the input image to generate a second image, and displaying the second image on the second display.

In an embodiment, the method may further include generating a first image signal corresponding to the input image, applying a gain to the first image signal to generate a second image signal, displaying the first image corresponding to the first image signal on the first display, and displaying the second image corresponding to the second image signal on the second display.

In another embodiment, the method may further include generating a first image signal corresponding to the input image, applying a gain to the first image signal to generate a second image signal, reading the gain, reversely applying the gain to the second image signal to generate a third image signal, displaying the first image corresponding to the third image signal on the first display, and displaying the second image corresponding to the second image signal on the second display.

In yet another embodiment, the method may further include generating a first image signal corresponding to the input image, applying a gain to the first image signal to generate a second image signal, reading the gain, determining lamp brightness of the first display corresponding to the gain, displaying the first image corresponding to the second image signal and the determined lamp brightness on the first display, and displaying the second image corresponding to the second image signal on the second display.

The method may further include determining an exposure degree of the first image signal and determining a gain according to the exposure degree of the first image signal.

The greater the gain is, the dimmer the lamp brightness may be adjusted.

The first display may include a non-self-light emission type panel.

The first and second displays may respectively display the first and second images in a live view mode.

The first and second displays may respectively display the first and second images in a manual mode.

An exemplary digital image signal processing apparatus for performing image signal processing on an input image to generate a captured image may include a first display which displays a first image corresponding to the input image and a second display which displays a second image generated by performing an exposure correction on the input image.

In an embodiment, the digital image signal processing apparatus may further include a first image signal generator which generates a first image signal and a gain applier which applies a gain to the first image signal to generate a second image signal, wherein the first display displays the first image corresponding to the first image signal, and the second display displays the second image corresponding to the second image signal.

In another embodiment, the digital image signal processing apparatus may further include a first image signal generator which generates the first image signal, a gain applier which applies a gain to the first image signal to generate a second image signal, a gain reader which reads the gain, and a gain reverse applier which reversely applies the gain to the second image signal to generate a third image signal, wherein the first display displays the first image corresponding to the third image signal, and the second display displays the second image corresponding to the second image signal.

In yet another embodiment, the digital image signal processing apparatus may further include a first image signal generator which generates a first image signal, a gain applier which applies a gain to the first image signal to generate a second image signal, a gain reader which reads the gain, and a lamp brightness determiner which determines lamp brightness of the first display corresponding to the read gain, wherein the first display displays the first image corresponding to the second image signal and the determined lamp brightness, and the second display displays the second image corresponding to the second image signal.

Embodiments, of the digital image signal processing apparatus may further include an exposure determiner which determines an exposure degree of the first image signal and a gain determiner which determines a gain according to the exposure degree determined by the exposure determiner, wherein the gain applier applies the gain determined by the gain determiner.

The first display may include a non-self-light emission type panel.

The first and second displays may respectively display the first and second images in a live view mode.

### BRIEF DESCRIPTION OF THE DRAWINGS

The above and other features and advantages of the present invention will become more apparent by describing in detail exemplary embodiments thereof with reference to the attached drawings listed below:

FIGS. 1A and 1B, 2A and 2B, and 3A and 3B respectively illustrate under-exposed and over-exposed input images, display images on displays, and output images in a conventional digital image signal processing apparatus.

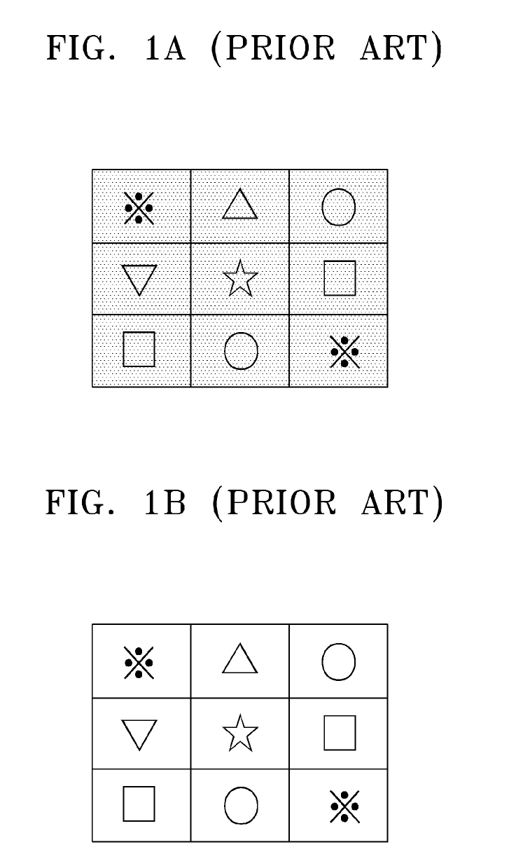

FIG. 4 is a flowchart of an exemplary method of controlling a digital image signal processing apparatus.

FIG. 5 is a flowchart of another exemplary method of controlling a digital image signal processing apparatus.

FIG. 6 is a flowchart of yet another exemplary method of controlling a digital image signal processing apparatus.

FIGS. 7A and 7B respectively illustrate an under-exposed input image and an over-exposed input image in an exemplary digital image signal processing apparatus.

FIG. 8A illustrates an exemplary digital image signal processing apparatus.

FIGS. 8B and 8C illustrate images displayed on displays in an exemplary digital image signal processing apparatus.

FIG. 9A illustrates an image that is captured as under-exposed in an exemplary digital image signal processing apparatus.

FIG. 9B illustrates an image that is captured as over-exposed in an exemplary digital image signal processing apparatus.

FIG. 10 is a block diagram of an exemplary digital image signal processing apparatus.

FIG. 11 is a block diagram of an exemplary display of FIG. 10.

FIG. 12 is a block diagram of another exemplary digital image signal processing apparatus.

FIG. 13 is a block diagram of an exemplary display of FIG. 12.

FIG. 14 is a block diagram of yet another exemplary digital image signal processing apparatus.

FIG. 15 is a block diagram of an exemplary display of FIG. 14.

### DETAILED DESCRIPTION

A method of controlling a digital image signal processing apparatus and the digital image signal processing apparatus operated by the method, according to exemplary embodiments, will now be described with reference to the attached drawings.

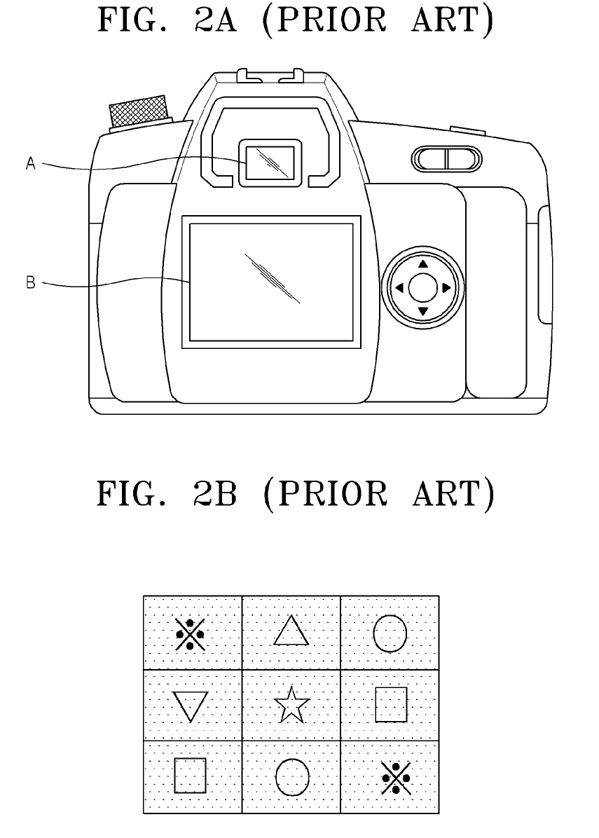

FIG. 4 is a flowchart of an exemplary method of controlling a digital image signal processing apparatus. Referring to FIG. 4, in operation S11, a live view mode may be executed.

An image may be input in real time, in the live view mode. In operation S12, a first image signal corresponding to the input image may be generated and temporarily stored.

In operation S13, an exposure degree of the input image corresponding to the first image signal may be determined. The exposure degree may be determined using a pixel value of the first image signal. For example, a sum of pixel values of pixels, a sum of pixel values of pixels of some areas, or the like, may be calculated to compare with a pre-set reference value. The determination may be performed to determine an exposure degree of an image signal in order to adjust the exposure degree of the image signal to an appropriate degree before an image corresponding to the image signal is displayed on a display.

If it is determined in operation S13 that the input image corresponding to the first image signal has been over-exposed (e.g., the exposure degree of the input image is higher than the pre-set reference value), a first gain corresponding to the over-exposure of the first image signal may be determined in operation S14. If it is determined in operation S13 that the input image has been appropriately exposed (e.g., the exposure degree of the input image corresponds to the pre-set reference value), a second gain corresponding to the appropriate exposure may be determined in operation S15. Otherwise, if it is determined in operation S13 that the input image has been under-exposed (e.g., the exposure degree of the input image is lower than the pre-set reference value), a third gain corresponding to the under-exposure may be determined in operation S16.

A gain determined as described above may be applied to the first image signal in operation S17. For example, the first gain, which may be lower than the second gain, may be applied to the over-exposed first image signal. The third gain, which may be greater than the second gain, may be applied to the under-exposed first image signal.

In operation S18, a second image signal may be generated and temporarily stored, through the application of the gain to the first image signal.

In operation S19, the first image corresponding to the first image signal may be displayed on a first display, and a second image corresponding to the second image signal may be displayed on a second display. For example, in the case of a digital camera, a first image corresponding to an input image may be displayed on a first display that is an electronic viewfinder (EVF), in order to facilitate a user's accurately pre-checking an image corresponding to a captured image. Also, an exposure of the input image may be corrected to generate a second image and the second image may be displayed on a second display, having a larger size than the first display, in order to display a second image that can be easily checked by the user.

The user may check the first image corresponding to the input image with the first display and/or the second image on which an exposure correction has been performed, with the second display, in order to determine whether to perform photographing. If the user performs photographing, a determination may be made as to whether a capture signal has been input to the digital image signal processing apparatus in operation S20. If it is determined in operation S20 that the capture signal has been input to the digital image signal processing apparatus, a photographed image signal may be generated in operation S21. If it is determined in operation S20 that the capture signal has not been input to the digital image signal processing apparatus, the method may return to operation S12 to sequentially input an image and generate and store a first image signal corresponding to the input image. Thereafter, operations S13 through S19 may be repeated.

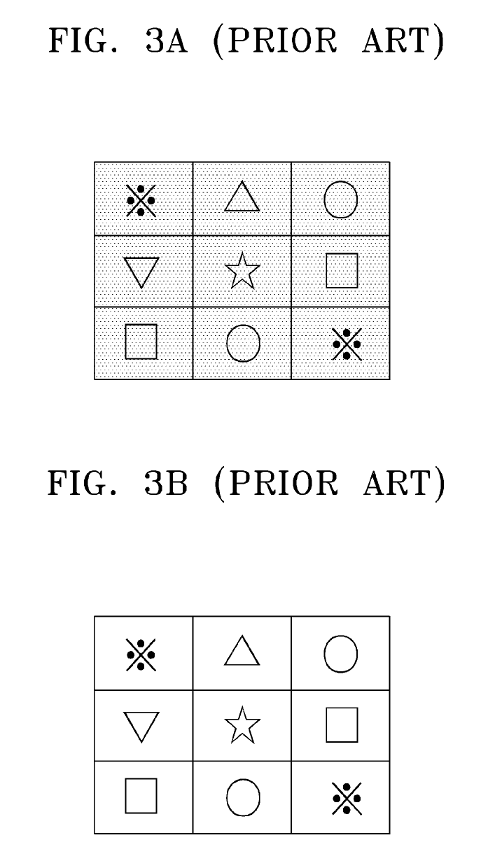

FIG. 5 is a flowchart of another exemplary method of controlling a digital image signal processing apparatus.

It has been described in the previous embodiment of FIG. 4 that images corresponding to first and second image signals may be displayed on first and second displays, respectively; however, it will be described in the present embodiment with reference to FIG. 5 that images may be displayed on first and second displays using a second image signal.

Referring to FIG. 5, a live view mode may be executed in operation S31.

In operation S32, a first image signal corresponding to an input image may be generated and temporarily stored in the live view mode.

In operation S33, an exposure degree of the input image may be determined. If it is determined in operation S33 that the input image has been over-exposed, the over-exposure may be determined as a first gain in operation S34. If it is determined in operation S33 that the input image has been appropriately exposed, the appropriate exposure may be determined as a second gain in operation S35. If it is determined in operation S33 that the input image has been under-exposed, the under-exposure may be determined as a third gain in operation S36. The exposure determination and the gain determination may be performed using a similar method to that described with reference to FIG. 4.

In operation S37, the determined gain may be applied to the first image signal. In operation S38, a second image signal may be generated and stored.

One of the first, second, and third gains determined in operations S34, S35, and S36 may be read in operation S39. In operation S40, the read gain may be reversely applied to the second image signal to generate and store a third image signal. Here, the reverse application of the read gain means that the application of the gain determined for the first image signal is reversely applied. The application of the gain may include a process of multiplying a pixel value of the first image signal by the gain; however, the reverse application of the gain may include a process of multiplying the second image signal by an inverse of the gain. Thus, the third image signal may be generated. As a result, the third image signal may correspond to the first image signal.

In operation S41, a first image corresponding to the third image signal may be displayed on a first display, and a second image corresponding to the second image signal may be displayed on a second display.

In operation S42, a determination may be made as to whether a capture signal has been input. If it is determined in operation S42 that the capture signal has been input, photographing may be performed to generate a photographed image signal in operation S43. If it is determined in operation S42 that the capture signal has not been input, the method may return to operation S32 to sequentially input an image and generate and store a first image signal. Thereafter, operations S33 through S41 may be repeated.

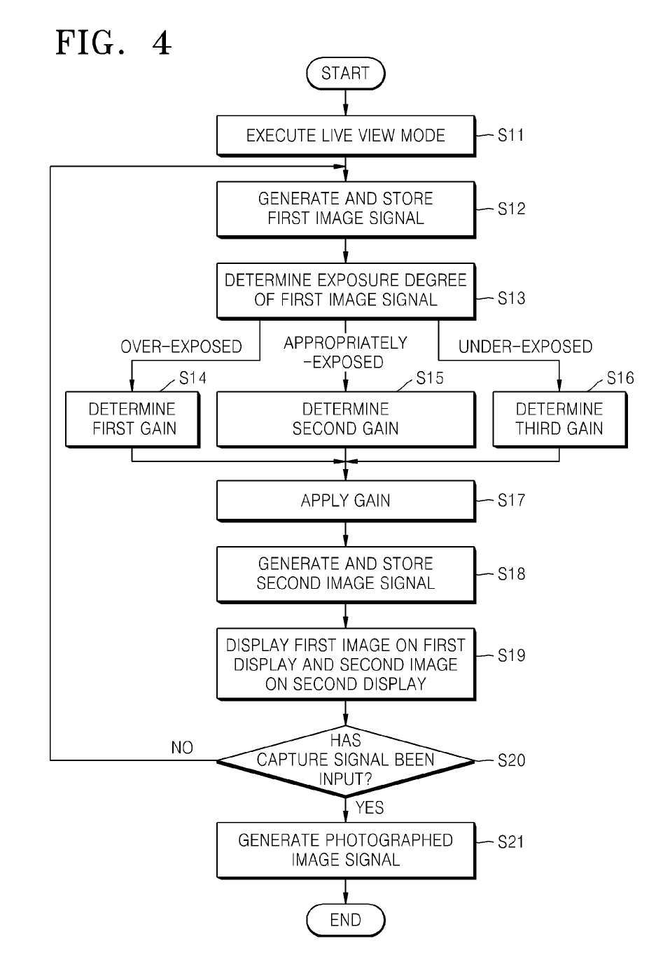

FIG. 6 is a flowchart of yet another method of controlling a digital image signal processing apparatus.

It has been described in the previous embodiment of FIG. 5 that images respectively different from image signals may be displayed on first and second displays, respectively. It will be described in the present embodiment with reference to FIG. 6 that the same image signals may be applied to the first display and the second display or the brightness of a lamp may be adjusted to display different images on the first display and the second display.

Referring to FIG. 6, in operation S51, a live view mode may be executed.

In operation S52, an image may be input in real time, in the live view mode, to generate and temporarily store a first image signal corresponding to the input image.

In operation S53, an exposure degree of the input image may be determined. If it is determined in operation S53 that the input image has been over-exposed, the over-exposure may be determined as a first gain in operation S54. If it is determined in operation S53 that the input image has been appropriately exposed, the appropriate exposure may be determined as a second gain in operation S55. If it is determined in operation S53 that the input image has been under-exposed, the under-exposure may be determined as a third gain in operation S56.

In operation S57, the gain that is determined as described above may be applied to the first image signal. In operation S58, a second image signal may be generated and temporarily stored.

In operation S59, the determined gain may be read. In operation S60, brightness of a lamp corresponding to the read gain may be determined. In the present embodiment, if a first display does not include a self-light emitting display (e.g., the first display includes a liquid crystal display (LCD) or the first display emits light using a lamp which is not included in the first display), the lamp may include a light-emitting source. Another image may be displayed according to an amount of the light emitted from the lamp. Thus, a database (DB) regarding brightness information of the lamp corresponding to the gain may be pre-stored, and the brightness information of the lamp corresponding to the gain may be obtained from the DB. As the gain is greater, the input image corresponding to the first image signal may be a dark image. Thus, the brightness information may be set so that the lamp emits dim light. As the gain is small, the input image may be a bright image. Thus, the brightness information may be set so that the lamp emits bright light.

In operation S61, a first image corresponding to the determined brightness information of the lamp and the second image signal may be displayed on a first display, and a second image corresponding to the second image signal may be displayed on a second display. For example, if an input image is a dark image, an appropriate gain may be applied to a first image signal corresponding to the input image to generate a second image signal so as to display a second image on a second display. A first image corresponding to lamp brightness information and the second image signal may be displayed on a first display, wherein the lamp brightness information has been adjusted to display the first image corresponding to a captured image that a user desires to obtain, specifically, to display an image similar to an input image to which a gain has not been applied.

In operation S62, a determination may be made as to whether a capture signal has been input. If it is determined in operation S62 that the capture signal has been input, photographing may be performed to generate a photographed image signal in operation S63. If it is determined in operation S62 that the capture signal has not been input, the method may return to operation S52 to input an image in real time and generate and store a first image signal corresponding to the input image. Thereafter, operations S53 through S61 may be repeated.

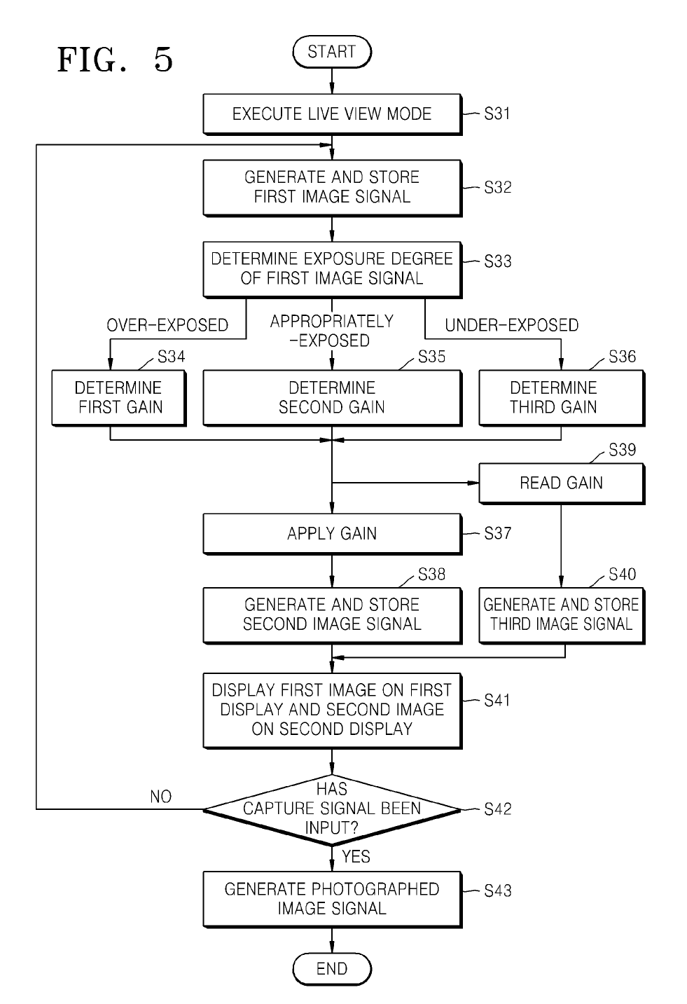

Images which are displayed in a live view mode according to the above-described exemplary methods in a digital camera including an EVF as a first display and an LCD as a second display will be described with reference to FIGS. 7A through 9B.

FIGS. 7A and 7B respectively illustrate an under-exposed input image and an over-exposed input image in an exemplary digital image signal processing apparatus.

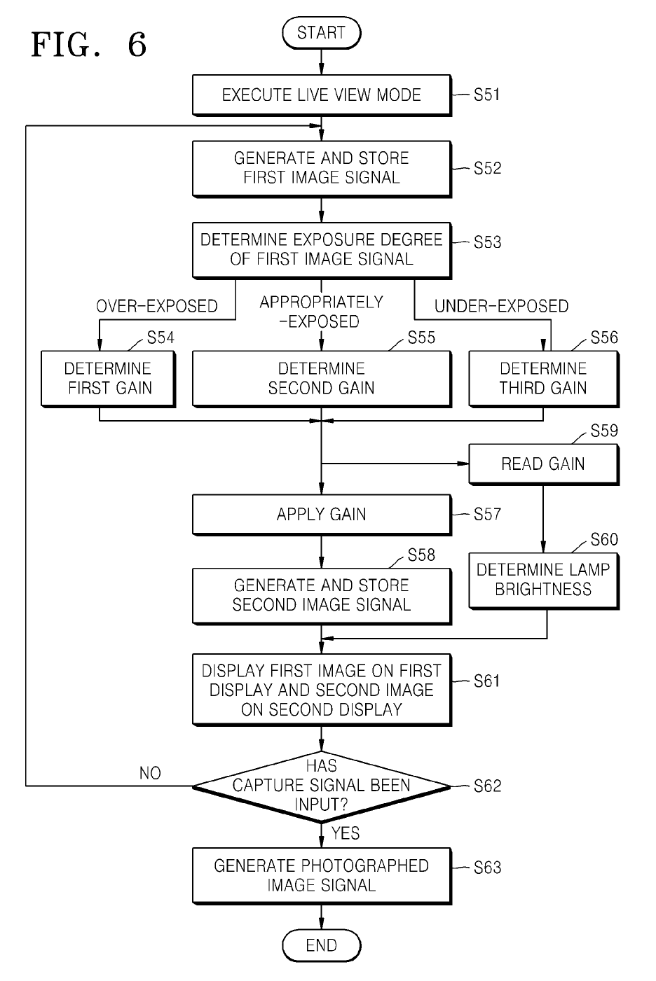

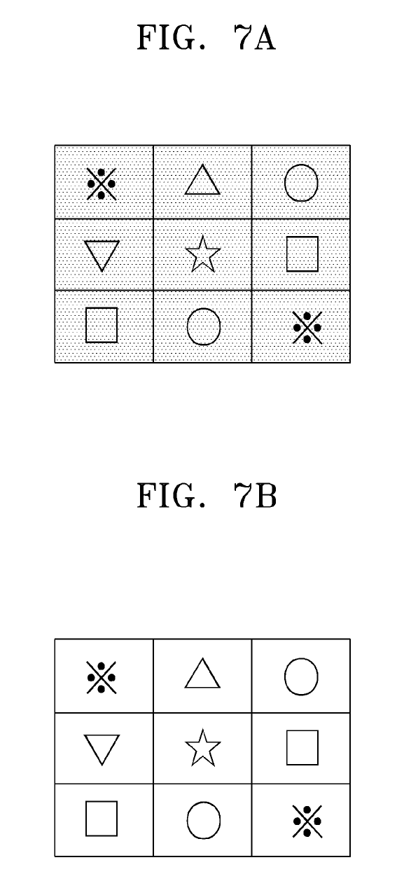

FIG. 8A illustrates an exemplary digital image signal processing apparatus. The digital image signal processing apparatus may display a second image, which is obtained by performing an exposure correction on the input image, on an LCD B in a live view mode. Thus, even if an external luminous intensity is high or low, a user may easily check a subject with the LCD B. A first image corresponding to the input image may be displayed on an EVF A.

FIGS. 8B and 8C illustrate images displayed on displays in the exemplary digital image signal processing apparatus of FIG. 8A. Referring to FIG. 8B, a first image corresponding to the input image of FIG. 7A may be displayed on the EVF A. Referring to FIG. 8C, a second image corresponding to the input image of FIG. 7B may be displayed on the EVF A. Therefore, a second image may be displayed on the EVF A, wherein the second image is generated without an exposure correction on an input image. Thus, a user may estimate a captured image and check the EVF A to perform photographing in order to obtain a desired image.

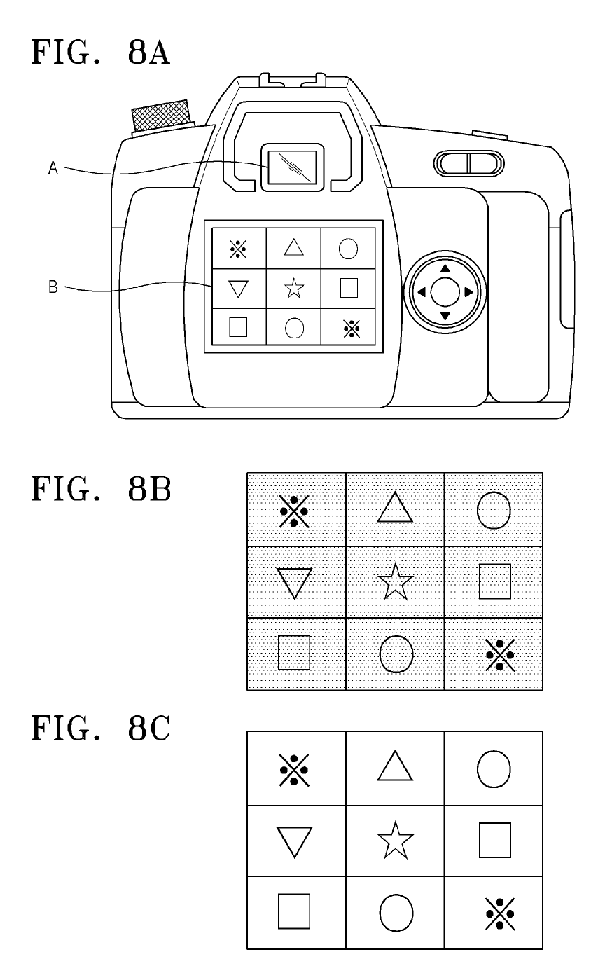

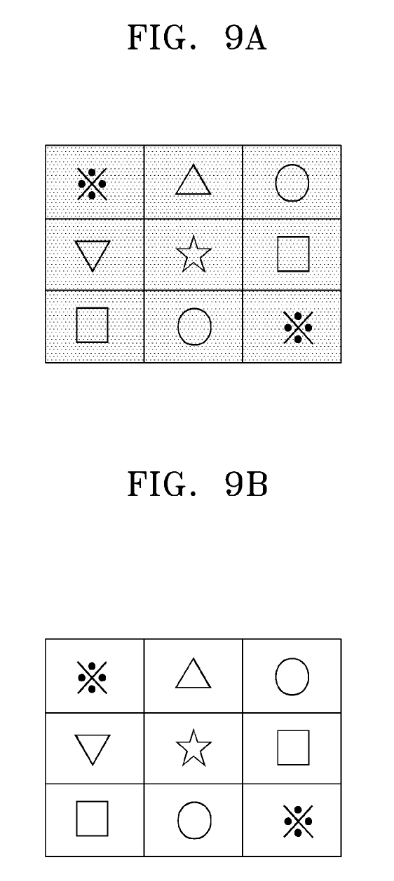

FIG. 9A illustrates an image that is captured as under-exposed in an exemplary digital image signal processing apparatus. FIG. 9B illustrates an image that is captured as over-exposed in an exemplary digital image signal processing apparatus. The captured image of FIG. 9A corresponds to the input image of FIG. 7A, and the captured image of FIG. 9B corresponds to the input image of FIG. 7B.

In the present embodiment, if photographing is performed in a manual mode such that a captured image is under-exposed or over-exposed, the EVF A and the LCD B may not display images which are obtained by performing exposure corrections on images input as under-exposed or over-exposed images; rather, the EVF A may display an image substantially input as under-exposed or over-exposed, and the LCD B may display an image on which an exposure correction has been performed. It may be difficult for a user to check the LCD B due to external conditions including a luminous intensity, etc. Thus, an exposure correction may be performed to display an image that can be easily checked by the user. It may not be relatively difficult for the user to check the EVF A due to the external conditions. Thus, the EVF A may display an image similar to an input image and/or a captured image.

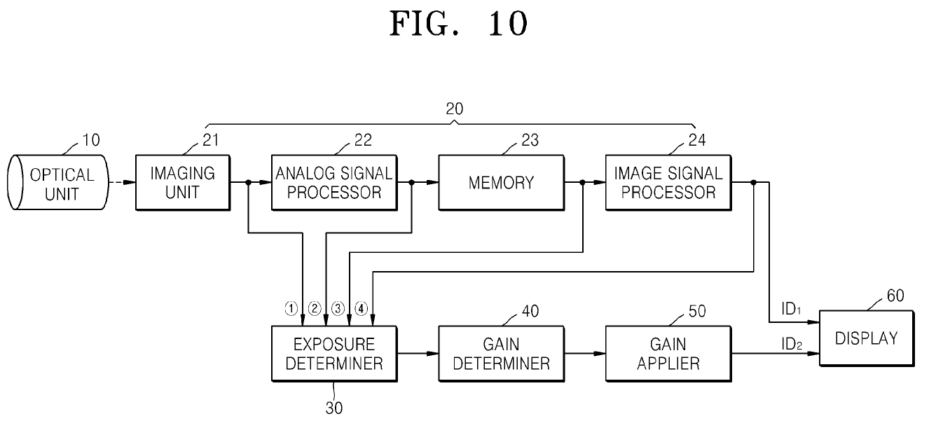

Digital image signal processing apparatuses operated according to the above-described exemplary methods will now be described with reference to FIGS. 10 through 15.

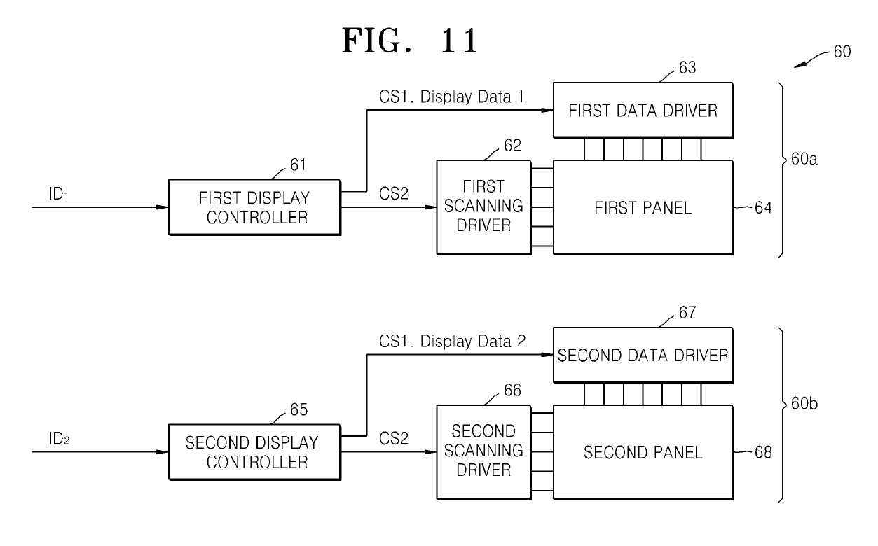

FIG. 10 is a block diagram of an exemplary digital image signal processing apparatus. FIG. 11 is a block diagram of an exemplary display 60 of FIG. 10.

Referring to FIG. 10, the exemplary digital image signal processing apparatus includes an optical unit 10, a first image signal generator 20, an exposure determiner 30, a gain determiner 40, a gain applier 50, and the display 60.

The optical unit 10 may transmit an optical signal obtained from a subject to an imaging unit 21. The optical unit 10 may include a lens which condenses the optical signal, an aperture which adjusts an intensity of the optical signal (intensity of light), a shutter which controls an input of the optical signal, etc. The lens may include a zoom lens which controls a view angle to be narrower or wider according to a focal length, a focus lens which adjusts a focus of the subject, etc. The zoom lens, the focus lens, etc., may constitute a lens or may include groups of lenses.

The optical unit 10 may be driven by an optical driver (not shown). The optical driver may drive a position of the lens, opening and closing of the aperture, an operation of a shutter, etc., according to an image input in real time and a control signal input by the user.

The first image signal generator 20 may include the imaging unit 21, an analog signal processor 22, a memory 23, and an image signal processor 24. A first image signal ID1 generated by the first image signal generator 20 may correspond to an image input in real time. The first image signal ID1 may include an electric signal corresponding to the input image imaged by the imaging unit 21. The electric signal may include a digital signal converted from an analog signal input to the analog signal processor 22. The first image signal ID1 may include the digital signal which is temporarily stored in the memory 23 and then output from the memory 23 to undergo predetermined image signal processing. The first image signal ID1 may include an image signal on which predetermined image signal processing has been performed by the image signal processor 24. Thus, in the present embodiment, the imaging unit 21, the analog signal processor 22, the memory 23, and the image signal processor 24, which may be capable of generating the first image signal ID1, may be collectively referred to as the first image signal generator 20.

The optical signal transmitted from the optical unit 10 may reach a light-receiving surface of the imaging unit 21 to form an image of the subject. The imaging unit 21 may include a Charge Coupled Device (CCD) or a Complementary Metal Oxide Semiconductor (CMOS) Image Sensor (CIS), which converts an optical signal into an electric signal. The imaging unit 21 may adjust a time required for accumulating charges, and an output time of the charges through a timing generator. Thus, the imaging unit 21 may control sensitivity, etc. The timing generator may control the imaging unit 21 based on image information which is input in real time.

The analog signal processor 22 may perform sampling and holding on an analog image signal provided from the imaging unit 21 to perform correlation double sampling on the analog image signal and convert the analog image signal, on which the correlation double sampling has been performed, into a digital image signal that is output to the memory 23 to be temporarily stored in the memory 23.

The image signal processor 24 may perform predetermined image signal processing on an image signal output from the memory 23. For example, noise of the image signal, which is converted from an analog image signal and stored in the memory 23, may be reduced. Also, image signal processing such as gamma correction, color filter array interpolation, color matrix, color correction, color enhancement, etc., may be performed on the image signal. Additionally, image data generated through image signal processing may be compressed to generate an image file from which image data may be recovered. The recovery processing may be performed in the image signal processor 24.

The exposure determiner 30 may determine an exposure degree of the first image signal ID1 generated by the first image signal generator 20. The first image signal ID1 may be provided through at least one of paths 1, 2, 3, and 4. The exposure determiner 30 may sum pixel values of the first image signal ID1 and compare the sum with a pre-set reference value in order to determine whether the first image signal ID1 has been under-exposed or over-exposed.

The gain determiner 40 may determine a gain corresponding to exposure information (e.g., the exposure degree) obtained by the exposure determiner 30. The gain corresponding to the exposure information may be made as a database (DB) and then stored. The gain determiner 40 may obtain the gain corresponding to the exposure information from the DB.

The gain applier 50 may apply the gain determined by the gain determiner 40 to the first image signal ID1. A level of the first image signal ID1 may be corrected to generate a second image signal ID2.

If the first image signal ID1 provided to the exposure determiner 30 includes an image signal provided through at least one of the paths 1, 2, and 3, the first image signal ID1 provided to the display 60 may include the image signal on which predetermined image signal processing has been performed to display an image corresponding to the image signal on the display 60. However, the predetermined image signal processing may not include a gain application for an exposure correction, like the second image signal ID2. This is because a gain is not applied to the first image signal ID1 to perform an exposure correction on the first image signal ID1, like the second image signal ID2.

The first and second image signals ID1 and ID2 may be output to the display 60.

The exemplary display 60 will now be described in detail with reference to FIG. 11. Referring to FIG. 11, the display 60 may include first and second displays 60a and 60b. The first display 60a may include a first display controller 61, a first scanning driver 62, a first data driver 63, and a first panel 64. The second display 60b may include a second display controller 65, a second scanning driver 66, a second data driver 67, and a second panel 68. LCDs, Electrophoretic Display Devices (EDDs), Organic Electroluminescent Displays (OELDs), or the like, may be used in the first and second displays 60a and 60b.

The first image signal ID1 may be input to the first display 60a, and then the first display controller 61 may generate first and second control signals CS1 and CS2 and first display data Display Data1 corresponding to the first image signal ID1, and transmit the second control signal CS2 to the first scanning driver 62 and the first control signal CS1 and the first display data Display Data1 to the first data driver 63. The first panel 64 may display a first image corresponding to the first image signal ID1 according to first data signals transmitted from the first data driver 63 and first scanning signals transmitted from the first scanning driver 62. Since a gain has not been applied to the first image signal ID1, the first image signal ID1 may correspond to a first image which is generated without an exposure correction on an input image.

A second image may be displayed on the second display 60b. The second image may correspond to the second image signal ID2 which is generated by applying a gain to the first image signal ID1. In other words, an exposure correction may be performed on an input image to generate the second image.

The second image signal ID2 may be input to the second display controller 65 that then generates first and second control signals CS1 and CS2 and second display data Display Data2 corresponding to the second image signal ID2. The first control signal CS1 and the second display data Display Data2 may be transmitted to the second data driver 67, and the second control signal CS2 may be transmitted to the second scanning driver 66. The second panel 68 may display the second image corresponding to the second image signal ID2 according to second data signals transmitted from the second data driver 67 and second scanning signals transmitted from the second scanning driver 66.

The first display 60a may be used to check an image input in a live view mode, and the second display 60b may have the same function as the first display 60a. However, the first display 60a may have a higher resolution than the second display 60b and thus may be used to accurately check the input image. Thus, a subject may be checked with the first display 60a rather than the second display 60b to obtain a desired captured image.

Although not illustrated in the present embodiment, the digital image signal processing apparatus may further include a central processing unit (CPU) which controls overall operations of the above-described elements of the digital image signal processing apparatus, an operator which inputs a capture signal and a control signal of a user, a memory which stores a program, a recording medium which stores a captured image, etc.

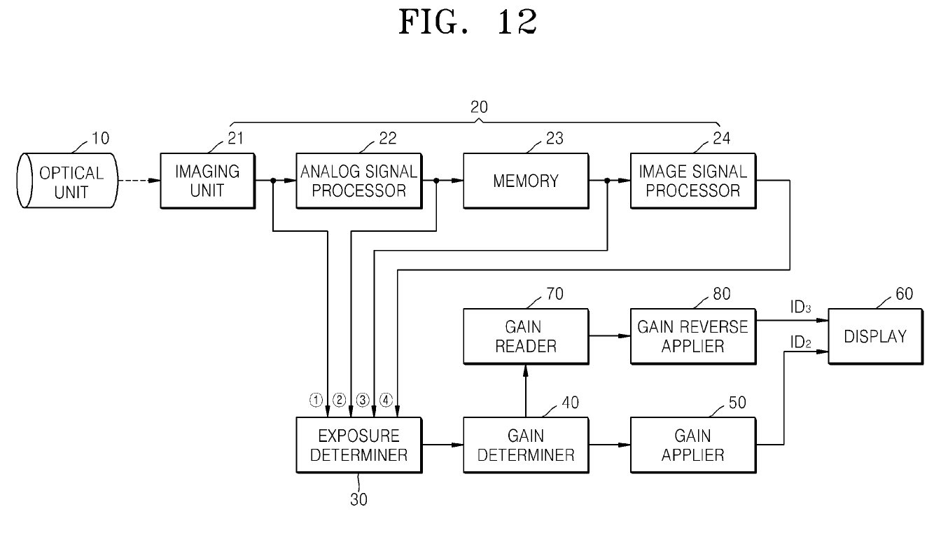

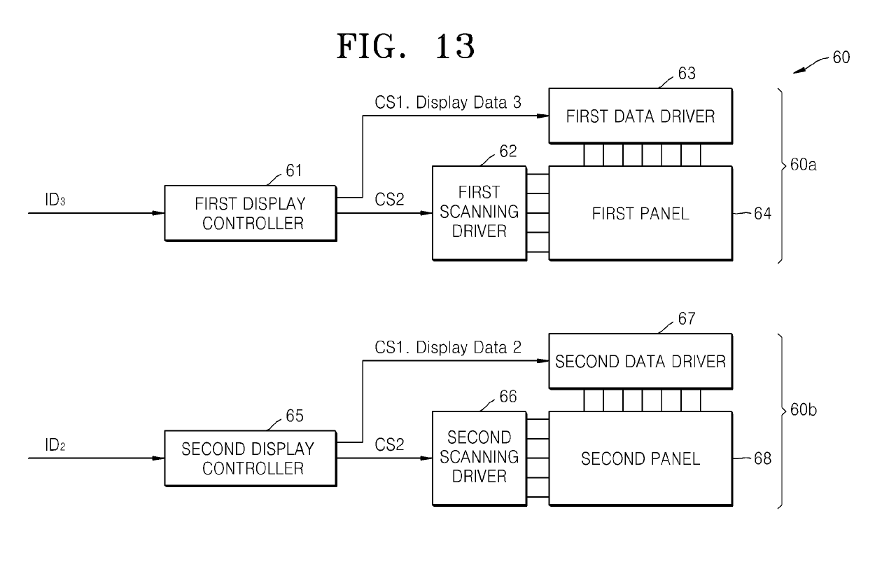

Another exemplary digital image signal processing apparatus and a display 60 will now be described in detail with reference to FIGS. 12 and 13. Some elements of the digital image signal processing apparatus of the present embodiment are similar to those of the digital image signal processing apparatus of FIG. 10, and thus only elements different from those of the digital image signal processing apparatus of FIG. 10 will be mainly described.

Referring to FIG. 12, a first image signal generator 20 may generate a first image signal corresponding to an image input to an optical unit 10. An exposure determiner 30 may determine an exposure degree of the first image signal, and a gain determiner 40 may determine a gain according to the determined exposure information. A gain applier 50 may apply the determined gain to the first image signal to generate a second image signal ID2. A luminance level of the first image signal may be corrected to generate the second image signal ID2.

A gain reader 70 may read the gain determined by the gain determiner 40. A gain reverse applier 80 may reversely apply the read gain to the first image signal to generate a third image signal ID3.

The second and third image signals ID2 and ID3 may be transmitted to the display 60.

Referring to FIG. 13, the third image signal ID3 may be transmitted to a first display controller 61 that then generates first and second control signals CS1 and CS2 and third display data Display Data3 corresponding to the third image signal ID3. The second control signal CS2 may be transmitted to a first scanning driver 62, and the first control signal CS1 and the third display data Display Data3 may be transmitted to a first data driver 63. A first panel 64 may receive signals from the first scanning driver 62 and the first data driver 63 to display a first image corresponding to the third image signal ID3. A gain may be reversely applied to the second image signal ID2 to generate the third image signal ID3. Thus, the third image signal ID3 may correspond to a first image signal ID1 to which a gain has not been applied. Therefore, the first image corresponding to the input image may be displayed.

As described with reference to FIG. 11, the second image signal ID2 may be transmitted to a second display controller 65, a second scanning driver 66, a second data driver 67, and a second panel 68. Thus, the second display 68 may display a second image corresponding to the second image signal ID2.

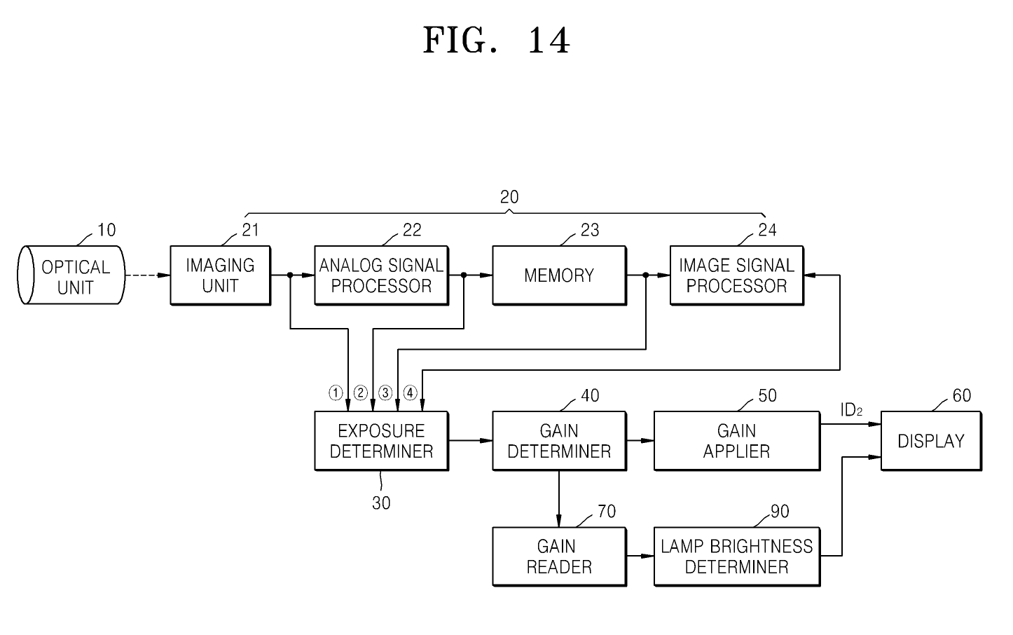

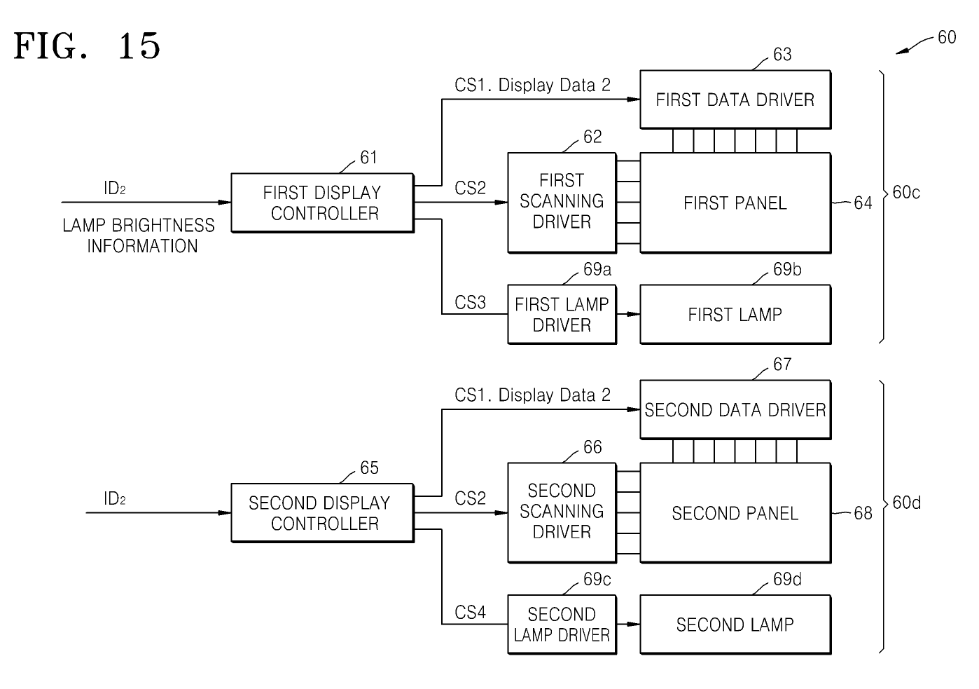

FIG. 14 is a block diagram of yet another exemplary digital image signal processing apparatus. FIG. 15 is a block diagram of an exemplary display 60 of FIG. 14. The exemplary display 60 of FIG. 15 includes a first display 60c which may include an embodiment of the first display 60a, and a second display 60d which may include an embodiment of the second display 60b. If in the present embodiment the first display 60c is not a self-light emitting display device (i.e., the first display 60c additionally includes a light source such as a lamp to display an image), the same image signal may be applied to the first display 60c and the second display 60d. Also, the brightness of the lamp may be adjusted to display another image. In the present embodiment, elements different from those of the digital image signal processing apparatuses of the previous embodiments will be mainly described.

Referring to FIG. 14, a first image signal generator 20 may generate a first image signal corresponding to an image input to an optical unit 10. An appropriate gain may be applied to the first image signal through an exposure determiner 30, a gain determiner 40, and a gain applier 50 to generate a second image signal ID2 that is transmitted to the display 60.

A gain reader 70 may read a gain determined by the gain determiner 40. A lamp brightness determiner 90 may determine a lamp brightness corresponding to the read gain. Lamp brightness information corresponding to a gain may be made as a DB, and then the lamp brightness information may be obtained from the DB. When the gain is great, the input image may include a dark image. Thus, the lamp brightness information may indicate that the brightness of a lamp is dim. When the gain is small, the input image may include a bright image. Thus, the lamp brightness information may indicate that the brightness of the lamp is bright.

Referring to FIG. 15, the second image signal ID2 and the lamp brightness information may be transmitted to a first display controller 61. The first display controller 61 may transmit first and second control signals CS1 and CS2 and second display data Display Data2 corresponding to the second image signal ID2 to a first panel 64 through a first scanning driver 62 and a first data driver 63. Also, the first display controller 61 may transmit a third control signal CS3 corresponding to the lamp brightness information to a first lamp driver 69a that drives a first lamp 69b to emit light at a brightness corresponding to the lamp brightness information. Thus, the first display 64 may display a first image on which an exposure correction has not been performed and which corresponds to the second image signal ID2 and the lamp brightness information.

The second image signal ID2 may be input to a second display controller 65 that then generates first, second, and fourth control signals CS1, CS2, and CS4 and second display data Display Data2 corresponding to the second image signal ID2. The second display controller 65 may transmit the second control signal CS2 to a second scanning driver 66, the first control signal CS1 and the second display data Display Data2 to a second data driver 67, and the fourth control signal CS4 to a second lamp driver 69c. A second panel 68 may receive data from the second scanning driver 66 and the second data driver 67 to display a second image. The second lamp driver 69c may drive a second lamp 69d to emit light at a brightness corresponding to the second image signal ID2 so as to display the second image on the second panel 68. The second image may correspond to a first image on which an exposure correction has been performed and which corresponds to an input image. The second image may be displayed on the second display 60d to facilitate a user in checking whether a subject is at high or low luminous intensity.

According to the embodiments as described above, a first display may display a first image that is equal or similar to an input image in a live view mode. Thus, a user may easily check with the first display an image that the user desires to capture. Also, a second display may display a second image on which an exposure correction has been performed. Thus, the user may easily check a subject with the second display, even at an inappropriate luminous intensity.

A program for executing a method of controlling a digital image signal processing apparatus according to the aforementioned embodiments or modifications thereof may be stored in a computer-readable storage medium. Examples of the storage medium include magnetic storage media (e.g., floppy disks, hard disks, or magnetic tape), optical recording media (e.g., CD-ROMs or digital versatile disks (DVDs)), and electronic storage media (e.g., integrated circuits (IC's), ROM, RAM, EEPROM, or flash memory).

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. It will be recognized that the terms “comprising,” “including,” and “having,” as used herein, are specifically intended to be read as open-ended terms of art.

What is claimed is:

1. A method of controlling a digital image signal processing apparatus which performs image signal processing on an input image to generate a captured image and comprises first and second displays, comprising:
displaying a first image corresponding to the input image on the first display;
performing an exposure correction on the input image to generate a second image; and
displaying the second image on the second display.

2. The method of claim 1, further comprising:
generating a first image signal corresponding to the input image;
applying a gain to the first image signal to generate a second image signal;
displaying the first image corresponding to the first image signal on the first display; and
displaying the second image corresponding to the second image signal on the second display.

3. The method of claim 2, further comprising:
determining an exposure degree of the first image signal; and
determining a gain according to the exposure degree of the first image signal.

4. The method of claim 1, further comprising:
generating a first image signal corresponding to the input image;
applying a gain to the first image signal to generate a second image signal;
reading the gain;
reversely applying the gain to the second image signal to generate a third image signal;
displaying the first image corresponding to the third image signal on the first display; and
displaying the second image corresponding to the second image signal on the second display.

5. The method of claim 4, further comprising:
determining an exposure degree of the first image signal; and
determining a gain according to the exposure degree of the first image signal.

6. The method of claim 1, further comprising:
generating a first image signal corresponding to the input image;
applying a gain to the first image signal to generate a second image signal;
reading the gain;
determining lamp brightness of the first display corresponding to the read gain;
displaying the first image corresponding to the second image signal and the determined lamp brightness on the first display; and
displaying the second image corresponding to the second image signal on the second display.

7. The method of claim 6, further comprising:
determining an exposure degree of the first image signal; and
determining a gain according to the exposure degree of the first image signal.

8. The method of claim 6, wherein the greater the gain is, the dimmer the lamp brightness is adjusted.

9. The method of claim 6, wherein the first display comprises a non-self-light emission type panel.

10. The method of claim 1, wherein the first and second displays respectively display the first and second images in a live view mode.

11. The method of claim 10, wherein the first and second displays respectively display the first and second images in a manual mode.

12. A digital image signal processing apparatus for performing image signal processing on an input image to generate a captured image, comprising:
a first display which displays a first image corresponding to the input image; and
a second display which displays a second image generated by performing an exposure correction on the input image.

13. The digital image signal processing apparatus of claim 12, further comprising:
a first image signal generator which generates a first image signal; and
a gain applier which applies a gain to the first image signal to generate a second image signal,
wherein the first display displays the first image corresponding to the first image signal, and the second display displays the second image corresponding to the second image signal.

14. The digital image signal processing apparatus of claim 13, further comprising:
an exposure determiner which determines an exposure degree of the first image signal; and
a gain determiner which determines a gain according to the exposure degree determined by the exposure determiner,
wherein the gain applier applies the gain determined by the gain determiner.

15. The digital image signal processing apparatus of claim 12, further comprising:
a first image signal generator which generates a first image signal;
a gain applier which applies a gain to the first image signal to generate a second image signal;
a gain reader which reads the gain; and
a gain reverse applier which reversely applies the gain to the second image signal to generate a third image signal,
wherein the first display displays the first image corresponding to the third image signal, and the second display displays the second image corresponding to the second image signal.

16. The digital image signal processing apparatus of claim 15, further comprising:
an exposure determiner which determines an exposure degree of the first image signal, and
a gain determiner which determines a gain according to the exposure degree determined by the exposure determiner,
wherein the gain applier applies the gain determined by the gain determiner.

17. The digital image signal processing apparatus of claim 12, further comprising:
a first image signal generator which generates a first image signal;
a gain applier which applies a gain to the first image signal to generate a second image signal;
a gain reader which reads the gain; and
a lamp brightness determiner which determines lamp brightness of the first display corresponding to the read gain,
wherein the first display displays the first image corresponding to the second image signal and the determined lamp brightness, and the second display displays the second image corresponding to the second image signal.

18. The digital image signal processing apparatus of claim 17, further comprising:
an exposure determiner which determines an exposure degree of the first image signal, and
a gain determiner which determines a gain according to the exposure degree determined by the exposure determiner,
wherein the gain applier applies the gain determined by the gain determiner.

19. The digital image signal processing apparatus of claim 17, wherein the first display comprises a non-self-light emission type panel.

20. The digital image signal processing apparatus of claim 12, wherein the first and second displays respectively display the first and second images in a live view mode.
